(19) United States
(12) Patent Application Publication
(10) Pub. No.: US 2008/0239885 A1
(43) Pub. Date: Oct. 2, 2008

(54) Magnetic Head for a Magneto-Optical Device and Magneto-Optical Device

(75) Inventors: Hans Willem Van Kesteren, Eindhoven (NL); Rudolf Johan Maria Vullers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkdlijke Philips Electronics N.V.

(21) Appl. No.: 10/567,214

(22) PCT Filed: Jul. 30, 2004
(86) PCT No.: PCT/IB04/51340

§ 371 Date: Feb. 3, 2006

(30) Foreign Application Priority Data
Aug. 8, 2003 (EP) 03102476.3

(51) Int. Cl. G11B 11/105; G11B 5/31

(52) U.S. Cl. 369/13.23; 369/13.41

(57) ABSTRACT

A magnetic head for a magneto-optical device comprises a plurality of substantially parallel planar layers, including at least one layer comprising a coil formed by a plurality of turns an electrically conductive winding, the turns lying substantially in a plane defined by the layer and the winding being substantially centered on a central axis perpendicular to the plane, and further including a yoke layer comprised of an anisotropic flux guiding material. The yoke layer comprises a plurality of segments (16) of flux guiding material dividing the yoke layer into sectors that together surround the central axis. In each sector, the flux guiding material has an easy axis in a plane of the yoke layer with a direction different from the direction of the easy axis in an adjacent sector.

The invention relates to a magnetic head for a magneto-optical device, comprising a plurality of substantially parallel planar layers, including at least one layer comprising a coil formed by a plurality of turns of an electrically conductive winding, the turns lying substantially in a plane defined by said layer and the winding being substantially centered on a central axis perpendicular to said plane, and further including a yoke layer comprised of an anisotropic flux guiding material.

The invention further relates to a magneto-optical device comprising a magnetic head.

An example of a magnetic head and magneto-optical device of the types mentioned above is known from U.S. Pat. No. 5,886,959. The known electromagnetic coil is intended for attachment to a slider in a flying optical or magneto-optical data storage system. The coil comprises an electrical conductor and is formed by means of available thin-film wafer processing techniques. A central optical passage is defined at the geometric center of the conductor for allowing an optical beam (e.g. a laser beam) to pass through. The conductor is coiled and encapsulated, at least in part, within an insulation layer. The insulation layer is covered by a yoke having a central optical opening that coincides with and is aligned with the optical opening of the coil. The optical or laser beam passes through the central optical openings for impinging upon a recording disk. The yoke is made of a suitable ferromagnetic high permeability material such as Ni₁₈Fe₁₉ nickel iron alloy.

A problem of the known magnetic head is that it is relatively inefficient. Thus, for a given power consumption, the field strength is either relatively low, or the number of turns, and consequently the self-inductance and switching time, is relatively high.

It is an object of the invention to provide a magnetic head and magneto-optical device of the types mentioned above that enable the attainment of lower switching times and higher magnetic field strength whilst keeping the power consumption relatively low.

This object is achieved by the magnetic head according to the invention, which is characterized in that the yoke layer comprises a plurality of segments of flux guiding material dividing the yoke layer into sectors which together surround the central axis, wherein, in each sector, the flux guiding material has an easy axis in a plane of the yoke layer with a direction different from the direction of the easy axis in an adjacent sector.

In use, the yoke layer and the recording medium are on opposite sides of the layer comprising the coil. Thus, the flux is concentrated towards the recording medium, giving a higher field strength at equivalent current values and coil turn numbers. Since the flux guiding material has an easy axis of magnetization in each sector with a direction different from the direction of the easy axis in an adjacent sector, the configuration makes it possible to obtain a magnetic head with substantial angles between the easy axis and the magnetic field lines, which run in the radial direction, over a larger part of the flux guiding material. This means that, over a large part of the flux guiding material, the coercive force is relatively low and the permeability at low field strengths is relatively high. As a consequence, the flux can follow fast variations in the current through the coil. The flux guiding efficiency averaged over the entire flux guide area is also increased.

Preferably, the easy axis of magnetization is substantially perpendicular to the radial direction along the bisector of each sector.

Thus, over the whole of the sector, the easy axis is as perpendicular to the field as possible, depending on the size of the segment defining the sector, i.e. the angle spanned by the sector.

In a preferred embodiment, the segments define the perimeters of an optical opening that is substantially centered on the central axis.

Thus, the magnetic head is suitable for use in a magneto-optical recording apparatus having a first-surface configuration, i.e. with the coil and the optics focusing the laser beam on the same side of the recording medium. This configuration is desirable because of the easier and more accurate alignment of the laser beam and the focus of the magnetic field that it allows.

In a preferred embodiment, the segments extend beyond a maximum dimension of the winding in the radial direction.

This has the effect of increasing the flux guiding efficiency and thus the focusing of the magnetic field towards the recording medium. In combination with the use of a metallic flux guide material, this configuration further improves the transport of heat away from the layer comprising the coil.

In a preferred embodiment, at least two adjacent segments are separated by an electrically insulating barrier.

The barrier may be air. This measure further increases the efficiency of the magnetic head by suppressing of eddy currents. It is relatively easy to manufacture, as the segments with differently oriented easy axes are formed separately anyway.

According to another aspect of the invention, a magneto-optical device is provided comprising a magnetic head according to the invention.

Given the required switching times and magnetic field strength for the optical recording application, the magneto-optical device shows a relatively low power consumption.

In an embodiment of the magneto-optical device, the magnetic head is integrated in an actuated movable body.

Since the magnetic head is Very efficient at generating a required magnetic field strength, it shows better performance: either the same magnetic field can be generated at a greater free working distance, making control of the actuated movable body easier, or a stronger magnetic field is generated for a conventional free working distance, which has the advantage of lower power consumption and dissipation. In the body of the magneto-optical device, the focusing optics and magnetic head can be integrated, making focusing easier.

The invention will be explained in further detail with reference to the accompanying drawings, in which:

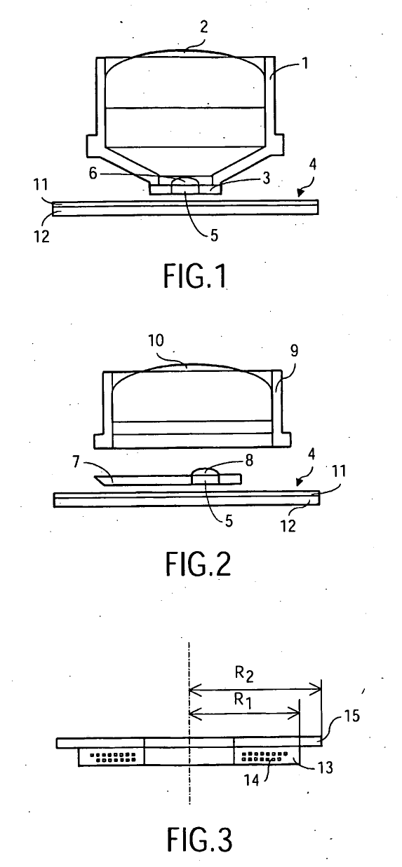

FIG. 1 is cross-sectional view of part of an actuated magneto-optical recording device incorporating an embodiment of the magnetic head;

FIG. 2 is a cross-sectional view of an assembly of an optical head and a slider incorporating an embodiment of the magnetic head;

FIG. 3 is a cross-sectional view of an embodiment of the magnetic head;

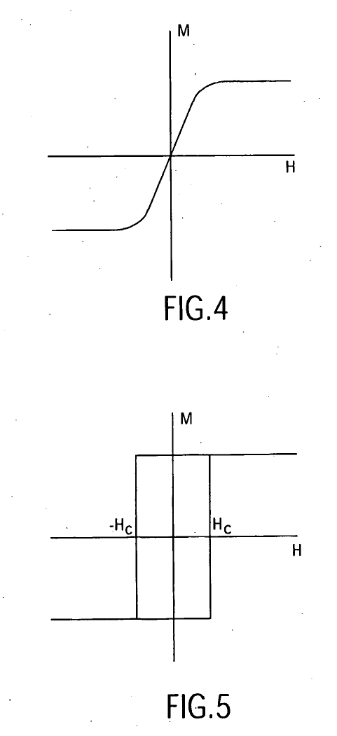

FIG. 4 is a diagram illustrating the hysteresis loop of a soft magnetic material in the presence of a magnetic field applied perpendicularly to the easy axis;

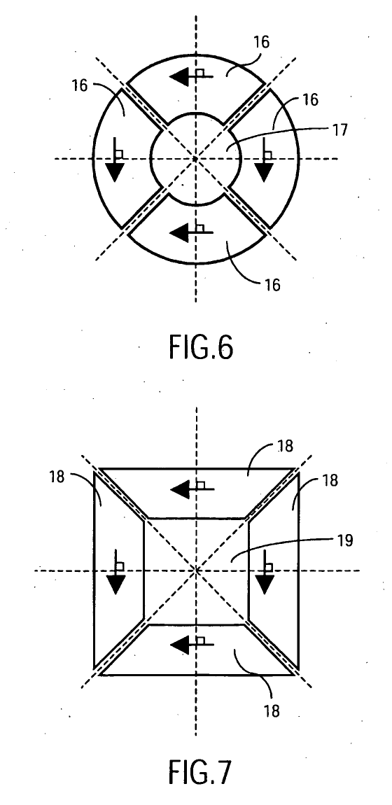

FIG. 5 is a diagram illustrating the hysteresis loop of a soft magnetic material in the presence of a magnetic field applied in a direction parallel to the easy axis

FIG. 6 shows a first configuration of flux guide segments;

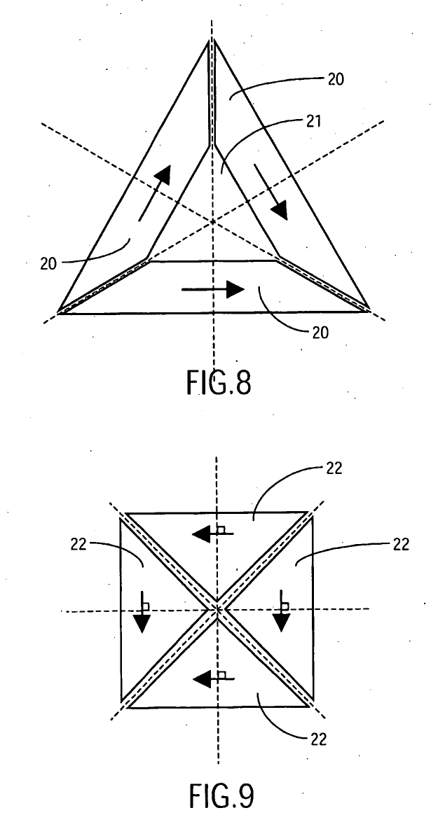

FIG. 7 shows a second configuration of flux guide segments;

FIG. 8 shows a third configuration of flux guide segments; and

FIG. 9 shows a fourth configuration of flux guide segments.

The recording head of which part is shown in FIG. 1 comprises a body 1, e.g. of metal. The body 1 is suspended in the recording head by means of actuators, for example co-operating coils and magnets (not shown), in a manner known per se. For example, the body 1 may be formed as an insert in a larger plastic carrier with permanent magnets and yokes placed around the actuation coils fixed to the insert. Thus, the body 1 forms an actuated movable body. The body 1 comprises a lens holder for holding a focusing lens 2. A magnetic head 3, the subject of the present application, is attached to the underside of the movable body 1, facing a disk-shaped recording medium 4. The magnetic head 3 comprises a transparent aperture 5, and an objective lens 6 is provided adjacent the transparent aperture 5. The objective lens 6 is an optional feature.

Although in this configuration the free working distance from the magnetic head 3 to the recording medium 4 is of the order of 2-15 μm, the special design of the magnetic head 3 enables a strong enough magnetic field to be applied for recording purposes at relatively low currents. It has the advantage of requiring only a single actuated body 1 and thus a simpler control mechanism.

In FIG. 2, the magnetic head is an integral part of a slider 7. The magnetic head likewise comprises a transparent aperture 5. An objective lens 8 is provided adjacent the transparent aperture 5. Focusing is achieved by means of an appropriate control loop, allowing adjustment of the position of an actuated optical head 9 comprising a lens 10. The configuration of FIG. 2 has the advantage that the free working distance between the magnetic head 3 and the recording medium 4 is smaller, in the order of 1-2 μm, and that the transparent aperture 5 as well as the winding surrounding can thus have a smaller diameter, leading to a more efficient coil or a lower self-inductance.

The invention is particularly suited for use in writing bits using Laser-Pulsed Magnetic Field Modulation, because the magnetic head 1 allows high switching frequencies. Read-out can be effected using Magnetic Super Resolution methods or Domain Expansion methods. The shown recording medium 4 is intended for use in the latter kind of method and comprises a thin-film stack 11 with a recording layer and a super-resolution or domain expansion readout layer on top of a substrate 12. It is noted that the thin-film stack 11 is not shown in more detail, as many different thin-film stack configurations are suitable for use with the magneto-optical head of the invention. For extra protection and to prevent lens contamination, a cover layer (not shown) of a few microns thickness may be applied on the thin-film stack 11 at the side opposite to the substrate.

It is observed that the configurations of FIGS. 1 and 2 are intended for so-called first-surface, air-incident or cover-layer incident recording, whereby both the lens system for focusing the laser beam onto the recording medium 4 and the magnetic head 3 for writing data onto the recording medium 4 are situated on the same side of the recording medium 4. However, certain embodiments of the magnetic head 3 could also be situated on an opposite side to the optical system for so-called substrate-incident recording. First-surface recording has the advantage that it is not necessary to align the focusing spot of the laser beam with the central axis of the magnetic head 3 during use, but only once during manufacturing. Also, a more compact magnetic head 3 can be used, as the area of the recording medium 4 through which the magnetic flux passes can be kept relatively small.

The magnetic head 3 is kept compact by the use of thin-film manufacturing technology. Referring to FIG. 3, it can be seen that the magnetic head 3 is built up of a plurality of substantially parallel planar layers. A coil layer 13 comprises a coil made of a winding comprising a plurality of turns 14. The coil is preferably of a type described in more detail in WO 01/82299. The advantage of using a coil made in thin-film technology is that such coils have a low self-inductance and a low capacitance and thus allow faster switching. They are also more compatible with first-surface recording, due to the compactness of the magnetic head 3 in the direction perpendicular to the recording medium.

In use, the coil layer 13 is situated between the recording medium 6 and a yoke layer 15. Both layers 13,15 are then substantially parallel to the recording medium 4. This configuration serves to concentrate the magnetic flux onto the recording medium 4. The yoke layer 15 comprises segments of flux guiding material. Examples of suitable materials are NiFe and CoZrNb. As can be seen in FIG. 3, the yoke layer 15 extends beyond a maximum dimension of the winding in a radial direction, defined to be perpendicular to a central axis on which the coil formed by the winding is substantially centered. In fact, in this example, the radius R₂ of the yoke layer 15 is greater than the radius R₁ of the coil layer 13. This improves the magnetic efficiency of the magnetic head 3. A further advantage is that it aids in transporting the heat dissipated in the turns 14 of the winding away from the coil layer 13, because the preferred materials used for the yoke layer 15, being metallic, also have good heat conducting properties.

In a preferred embodiment, the flux guiding material is covered at least partly by a non-magnetic heat-conducting layer. This heat-conducting layer can be made of copper, gold or silver, for example. In one embodiment, the surface area of the yoke layer 15 facing away from the coil layer 13 is covered, partly or completely, by a layer of material having good heat-conducting properties. Alternatively or additionally, part or all of the outer perimeter of the yoke layer 15 could be covered by such material.

Soft-magnetic thin films as applied for the yoke layer 15 often show an anisotropic permeability, meaning that the magnetic permeability, or flux guiding ability, of the segments is not equal in all directions. The highest permeability is found along a direction perpendicular to the easy axis. Depositing the soft-magnetic film in an external magnetic field can enhance the anisotropy. The magnetic field during deposition determines the easy axis direction, which will in any case be parallel to the plane of the yoke layer 15.

The magnetization curve of the material as measured when the magnetic field is perpendicular to the easy axis is shown in FIG. 4, and the curve measured when it is parallel to the easy axis is shown in FIG. 5. It will be recognized that, when a magnetic field H is applied in a direction parallel to the easy axis, the flux guiding efficiency at values of the magnetic field strength H below the coercive force H_{c} is poor and the magnetization changes irregularly around the value of the coercive force H_{c}. By contrast, referring to FIG. 4, when the field is applied perpendicularly to the easy axis, the magnetization reacts to the applied field with a rotation of the magnetization towards the direction of the applied field. The coercive force H_{c} is very low and the permeability at low values of the magnetic field strength H is high. Furthermore, a change in the direction (i.e. sign) of the magnetic field does not lead to substantial discontinuities in the value of the magnetic permeability.

FIGS. 6-9 are views along the central axis of the magnetic head 3 of representative examples of configurations of the yoke layer 15. Referring first to FIG. 6, four segments 16 of anisotropic flux guiding material are shown, with the easy axis of each section marked by an arrow. The segments 16 divide the area surrounding the central axis into four sectors of equal size, each spanning an angle of substantially 90°. The easy axis direction is different in adjacent sectors such that, at each point within each segment, the easy axis direction encloses an angle of at least 45° with a radial direction from the central axis through said point. Preferably, the easy axis is substantially perpendicular to the radial direction along a line bisecting the sector formed by a segment 16. This ensures that the magnetization curve is as close an approximation to the curve of FIG. 4 as possible. A higher flux guiding efficiency at low field strengths and better switching properties are achieved thereby. The magnetic head 3 comprising the segments 16 is suitable for first-surface recording, as the edges of the segments 16 situated nearest to the central axis define an opening 17. The opening 17 may be filled by an optically transparent material, or left completely open.

In FIG. 7, the yoke layer 15 also comprises four segments 18, again defining four sectors of substantially 90°. As in the configuration of FIG. 6, the easy axis of v magnetization is, at each point of a segment 18, at an angle to a radial direction from the central axis through that point, and in a different direction for adjacent segments 18. The configuration of FIG. 7 serves to emphasize that the division into sectors of the area surrounding the central axis does not imply that the segments are delineated by arcs, or indeed form a rotationally symmetrical shape, but that other planar shapes are also possible. The edges of each of the segments 18 nearest to the central axis define the perimeter of an optical opening 19.

In FIG. 8, the area surrounding the central axis is divided into three sectors of approximately 120° in size, i.e. segments 20 in the shape of trapeziums. The easy axis of magnetization of each segment 20 is substantially perpendicular to the radial direction along the bisector of each sector, and thus in a different direction for adjacent sectors. The inner edges of the segments 20 define an optical opening 21, allowing this configuration also to be used for air-incident recording.

The embodiment shown in FIG. 9 is not suitable for first-surface recording, as it does not comprise an optical opening. Otherwise, the configuration of FIG. 9 is similar to that of FIGS. 6 and 7, in that four segments 22 of anisotropic magnetic flux guiding material define four sectors of about 90°, each having an easy axis of magnetization which at each point is at an angle to a radial direction from the central axis through said point, and thus in a different direction for adjacent sectors each time.

It is observed that the number of segments may be increased to five, six, seven or eight, or even more, with a corresponding decrease in the size of the sectors. Increasing the number of segments will increase the efficiency of the magnetic head 3. However, this will require a more complicated thin-film manufacturing process.

To form the yoke layer 15, a layer of the soft magnetic material is applied by electroplating and/or sputter deposition while a magnetic field is being applied to induce an easy axis in the desired direction. Subsequently, a layer of photoresist is added and then exposed through a mask. The unexposed photoresist is removed, leaving only a layer covering the segments with parallel easy axes in the desired direction. The rest of the applied material is removed by etching. Subsequently, the process is repeated to form one or more segments with differently oriented easy axes. Thus, the more segments there are, the more process steps are needed. An even number of segments is preferred, as the segments can then be formed in pairs, one pair for each processing step, and each pair situated on opposite sides of the central axis. For this reason, four is a preferred number of segments, being the maximum number of segments that can be formed in two processing steps and the minimum number of steps required to divide the yoke layer 15 into at least three sectors.

Preferably, the photoresist is applied and the masks used are arranged such that the segments of the yoke layer are electrically insulated from one another, for example by leaving a small space between the segments. Thus, eddy currents running in a tangential direction through the yoke layer 15 will be suppressed. This will improve the high-frequency behaviour of the magnetic head, important for its application in MFM recording. It is noted that some effect is already achieved if only two adjacent segments are separated by an electrically insulating barrier, for example an air gap.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

Thus, for example, the segments may be divided into further sub-segments each with an easy axis of magnetization in the same direction, but each electrically insulated from the other sub-segments. This further suppresses the occurrence of eddy currents. The term ‘segment’ does not, therefore, necessarily imply a continuous piece of soft magnetic material.

1. Magnetic head for a magneto-optical device, comprising a plurality of substantially parallel planar layers (13,15), including a layer (13) comprising a coil formed by a plurality of turns (14) of an electrically conductive winding, the turns (14) lying substantially in a plane defined by the layer (13) and the winding being substantially centered on a central axis perpendicular to the plane, and further including a yoke layer (15) comprised of an anisotropic flux guiding material, wherein the yoke layer (15) comprises a plurality of segments (16;18;20;22) of flux guiding material dividing the yoke layer (15) into sectors which together surround the central axis, wherein, in each sector, the flux guiding material has an easy axis in a plane of the yoke layer with a direction different from the direction of the easy axis in an adjacent sector.

2. Magnetic head according to claim 1, wherein the easy axis of magnetization is substantially perpendicular to the radial direction along the bisector of each sector.

3. Magnetic head according to claim 1, wherein the segments (16;18;20) define the perimeters of an optical opening (5;17;19;21) that is substantially centered on the central axis.

4. Magnetic head according to claim 1, wherein the segments (16;18;20;22) extend beyond a maximum dimension of the winding in the radial direction.

5. Magnetic head according to claim 1, wherein at least two adjacent segments (16;18;20;22) are separated by an electrically insulating barrier.

6. Magnetic head according to claim 1, wherein the segments (16;18;22) divide the yoke layer (15) into four sectors.

7. Magnetic head according to claim 1, wherein turns (14) closer to the central axis have a smaller width than turns (14) further away from the central axis.

8. Magnetic head according to claim 1, wherein the flux guiding material is covered at least partly by a non-magnetic heat-conducting layer.

9. Magneto-optical device comprising a magnetic head (3) according to claim 1.

10. Magneto-optical device according to claim 9, wherein the magnetic head (3) is integrated in an actuated movable body (1).
